(19) United States
(12) Patent Application Publication
(10) Pub. No.: US 2012/0025091 A1
(43) Pub. Date: Feb. 2, 2012

(54) METHOD OF COINCIDENCE DETECTION AND TOMOGRAPHY SYSTEM USING THE SAME

(75) Inventors: TZONG-DAR WU, Taoyuan County (TW); Chung-Hung Chang, Taoyuan County (TW); Meei-Ling Jan, Taoyuan County (TW)

(73) Assignee: Institute of Nuclear Energy Research Atomic Energy Council Executive Yuan, Taoyuan County (TW)

(21) Appl. No.: 13/191,735

(22) Filed: Jul. 27, 2011

(30) Foreign Application Priority Data
Jul. 27, 2010 (TW) 099124684

(51) Int. Cl. G01T 1/172

(52) U.S. Cl. 250/394; 250/395

(57) ABSTRACT

A method of coincidence detection and a tomography system using the same are provided. In the method and system, by combining original trigger signals and time mark information, at a time point of a rising edge of a system main clock, a combination of the trigger signals of a plurality of radiation detectors of the system is obtained, and a type of the combination of the trigger signals is determined according to a predetermined event relation. If the combination of the trigger signals belongs to an effective event, a time mark procedure is utilised for judging the trigger signals in the event, in which it is determined whether a difference between two time mark information respectively associated with the trigger signals of the two corresponding radiation detectors is within a coincidence time window or not, thereby judging whether the effective event is an annihilation event.

### BACKGROUND OF THE INVENTION

1. Field of Invention

The present invention relates to a coincidence detection technology, and more particularly, to a method of coincidence detection and a tomography system using the same in which event recognition is performed by combining detection of trigger signals using a signal rising edge of a main clock and a time difference associated to the trigger signals.

2. Related Art

Positron Emission Tomography (PET) performs medical examination to creatures by using isotope medicine with little radioactivity. After intravenously injecting glucose with radioactive medicine in the body of a creature, the medicine is absorbed by malignant cells in a large amount, positrons during the decay process impact with electrons in the cells to counteract with each other thus generating annihilation, the mass disappears and two γ-rays in opposite directions and having an included angle of 180 degrees are emitted, in which each γ-ray has an energy of 511 keV. A PETCT detects the γ-rays in pairs, so as to rebuild distribution situation of the positron medicine in tissues or organs, thus obtaining a required image.

In the prior art, three kinds of methods are provided to detect the two γ-rays generated in the same annihilation event, namely, a time mark method, a trigger signal AND logic method, and a hybrid method. In the time mark method, a coincidence detection system circuit sorts time marks sent by all radiation detectors in a fixed time period, and calculates a difference between the time marks of the matching radiation detectors, so as to determine whether the difference of the time marks corresponding to the matching radiation detector modules is within a predetermine coincidence time window, and if the difference of the time marks is smaller than a value of the coincidence time window, it is judged that a coincidence occurs to this matching combination. This method can provide a precise time resolution; however, the complexity thereof increases along with the increase of a digital value length of the time mark, thus causing poor real-time performance of the detection system circuit.

In the trigger signal AND logic method, trigger signals output by all possible matching radiation detectors are detected, through an “AND” logic gate, to see whether the trigger signals are generated at the same time. Particularly, all possible combinations of matching radiation detectors are found in advance, trigger signals of the two radiation detectors of each combination are made to pass through an AND logic gate, and when the two matching trigger signals are in the high level at the same time, the AND logic gate generates a high level, thus judging that a coincidence occurs to this matching combination. This method is real-time, quick and simple, and saves the matching event sorting in the time mark method, thus greatly reducing the system complexity and being easily implemented on a hardware circuit. However, a size of the coincidence time window is determined by a pulse width of the trigger signal, which is not suitable for being altered or adjusted in real time, and the trigger signal is easy to be affected by noises of the circuit and elements.

Finally, in the hybrid method, the conventional trigger signal AND logic method is used to perform preliminary screening, and the matching modules after the screening undergo the time mark method to perform the final judgment of the coincidence. Particularly, an original trigger signal output by each radiation detector module is synchronized with a system main clock, so as to obtain a synchronized trigger signal. Then, all possible combinations of matching radiation detector modules are found out, the synchronized trigger signals of the two matching modules in each combination are made to pass through an AND logic gate, and when the two matching synchronized trigger signals are in the high level at the same time, the AND logic gate generates a high level, thus preliminarily judging that a coincidence occurs to this matching combination. In the second stage, the candidate matching modules of the coincidence selected from the preliminary screening undergo the time mark method to judge the coincidence, in which detailed final judgment is performed on time marks output by the selected matching modules, so as to determine whether the coincidence is real or not.

### SUMMARY OF THE INVENTION

The present invention is directed to a method of coincidence detection and a tomography system using the same, which is a hybrid coincidence detection system circuit combining original trigger signals and time marks. In a preliminary screening stage, a look-up table method is used, a logic stage of an original trigger signal output by each radiation detector serves as an address of an event relation table, and in a rising edge of a system main clock, the trigger signals of all radiation detectors are scanned and corresponding addresses are determined according to combinations of the trigger signals. Then, the table is looked up to output matching information codes established in the table in advance. Therefore, in the present invention, at the instant of the period leading edge of the system main clock, preliminary screening of matching radiation detectors to which a coincidence may possibly occur and corresponding information coding are completed at the same time. In the subsequent second stage, the candidate matching radiation detectors of the coincidence selected in the preliminary screening undergo the time mark method to judge the coincidence, a sequence of the trigger signals of the two matching radiation detectors is defined, and a detailed final judgment is performed on time marks corresponding to the selected matching modules, thus determining whether the coincidence is real or not.

The present invention is directed to a method of coincidence detection and a tomography system using the same, which are capable of completing tasks, such as preliminary screening of event matching, matching information coding, and determination of whether a single or multiple coincidences occur, at the instant of a rising edge of a system main clock. Therefore, as compared with the conventional hybrid method in which the trigger signal AND logic method is used to perform preliminary screening of the coincidence first and coding and multiple event judgment are performed later, the present invention has advantages such as good real-time performance, rapidness, and high integrity in terms of real-time computation, and the event relation table is easy to be implemented by a memory module in hardware.

The present invention is directed to a method of coincidence detection and a tomography system using the same, in which only time marks of modules that may possibly have a coincidence after preliminary screening are compared, thus avoiding the process of complicatedly comparing all time mark signals in the conventional pure time mark method. After the preliminary screening, the judgment of a coincidence is finally performed through the time mark method, so as to avoid the distortion due to the affect of noise or interference when merely the trigger signals are used to perform judgment, thus reducing the probability of event misjudgment. Therefore, the present invention has high detection precision of the convention hybrid method and time mark method, and is capable of reducing the complexity of the coincidence detection system circuit, and improving the real-time performance and integrity of the system.

In an embodiment, the present invention provides a method of coincidence detection, which includes the following steps. A tomography system is provided. The system has a plurality of radiation detectors and generates a main clock signal, in which each radiation detector detects a radiation event, so as to generate a corresponding trigger signal. A plurality of trigger logic states of the plurality of radiation detectors is classified to establish an event relation. A first trigger signal combination of the plurality of radiation detectors is scanned at a time point of a first rising edge of the main clock signal. It is determined whether the first trigger signal combination is an effective event according to the event relation. Finally, it is judged whether the effective event is an annihilation event by using a time mark procedure.

In another embodiment, the present invention further provides a tomography system, which includes: a main clock generator, for generating a main clock signal; a plurality of radiation detectors, for respectively detecting a radiation event to generate a corresponding trigger signal; a memory module, for storing an event relation established by classifying a plurality of trigger logic states of the plurality of radiation detectors and a time mark associated to the trigger signal; and a control unit, for scanning a first trigger signal combination of the plurality of radiation detectors at a time point of a first rising edge of the main clock signal, determining whether the first trigger signal combination is an effective event according to the event relation, and if yes, judging whether the effective event is an annihilation event by using time marks corresponding to the trigger signals in the effective event.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a tomography system according to an embodiment of the present invention;

FIG. 2 is a schematic flow chart of a method of coincidence detection according to an embodiment of the present invention;

FIGS. 3A to 3E are schematic views of various scanning states;

FIG. 4 is a schematic flow chart of judging whether an effective event is an annihilation event;

FIG. 5A is a schematic view of two matching radiation detectors having trigger signals;

FIG. 5B is a schematic view of a difference of time marks; and

FIGS. 6A and 6B are schematic views of two scanning performed on a single trigger signal event.

### DETAILED DESCRIPTION OF THE INVENTION

In order to make the features, objectives, and functions of the present invention more comprehensible, a detailed structure of a device of the present invention and a design idea thereof are further described in detail below, for the Examiner to understand the characteristics of the present invention.

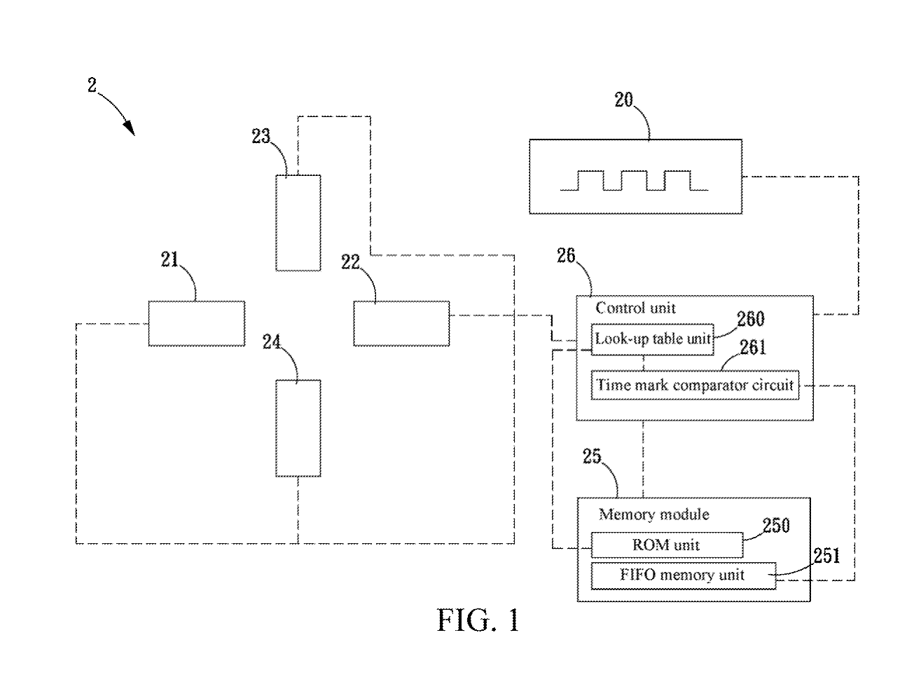

Referring to FIG. 1, a schematic view of a tomography system according to an embodiment of the present invention is shown. The tomography system 2 includes: a main clock generator 20, a plurality of radiation detectors 21-24, a memory module 25, and a control unit 26. The main clock generator 20 is used for generating a main clock signal. The plurality of radiation detectors 21-24 is used for respectively detecting a radiation event (for example, γ-ray) to generate a corresponding trigger signal. The mode of generating the trigger signal belongs to the conventional art, and is not repeated herein. In this embodiment, every two of the plurality of radiation detectors 21-24 are considered as a group, and the two are corresponding to each other, such that the plurality of radiation detectors 21-24 is divided into two groups. It should be noted that, the number of the radiation detectors is determined according to actual demand, and is not limited by the number shown in the embodiment of FIG. 1.

The memory module 25 is used for storing an event relation established by classifying a plurality of trigger logic states of the plurality of radiation detectors 21-24 and a time mark associated to the trigger signal. It should be noted first that, the event relation is basically a look-up table, which is stored in a read-only memory (ROM) unit 250 of the memory module 25. As shown in Table 1, the look-up table takes a plurality of trigger logic states that may possibly occur to the plurality of radiation detectors as addresses, and classifies the plurality of trigger logic states, in which each classification is allocated with one information code as a representative. The address field of Table 1 takes four bits as information describing the address, and in the address expression, the four bits from high to low respectively represent a first group of radiation detectors 21 and 22 and a second group of radiation detectors 23 and 24. When the radiation detector has a trigger signal, the corresponding bit has a value of “1”, and when the radiation detector does not have the trigger signal, the corresponding bit has a value of “0”. The classifications of the plurality of logic trigger states represented by the addresses include five types of information codes, namely, “0000”, “0001”, “0010”, “0011”, and “0100”, in which the information code (0000) indicates that no trigger signal exists, the information code (0001) indicates a single trigger signal, the information code (0010) indicates two trigger signals belonging to non-matching modules, the information code (0011) indicates two trigger signals belonging to the matching radiation detector combination, and the information code (0100) indicates a matching information code of different types such as multiple trigger signals (three trigger signals or more).

TABLE 1
Look-Up Table

| Address | Information Code |
|---|---|
| 0000 | 0000 |
| 0001 | 0001 |
| 0010 | 0001 |
| 0011 | 0011 |
| 0100 | 0001 |
| 0101 | 0010 |
| 0110 | 0010 |
| 0111 | 0100 |
| 1000 | 0001 |
| 1001 | 0010 |
| 1010 | 0010 |
| 1011 | 0100 |
| 1100 | 0011 |
| 1101 | 0100 |
| 1110 | 0100 |
| 1111 | 0100 |

The content of Table 1 is stored in the ROM in the form of electronic signals, for being looked up. It should be noted that, four radiation detectors are used in this embodiment, and thus four bits are used to represent the address, and if eight radiation detectors are used, the address is represented by eight bits. Therefore, the number of bits of the address represents the number of the radiation detectors. In addition, the information code mainly reflects five different classifications, and thus the coding mode of the information code is not limited to this embodiment, and may be defined by users as desired.

Moreover, a first-in first-out (FIFO) memory unit 251 in the memory module 25 is used for recording time marks associated to the trigger signals. When an annihilation event occurs, a pair of γ-rays having an included angle of 180 degrees is generated, and when the radiation detector detects one of the γ-rays, a trigger signal is generated in a method as described in the following. Each radiation detector module uses a constant fraction discriminator (CFD) or a level trigger to send a square wave at an instant of detecting a leading edge of a photoelectric pulse signal generated by the γ-ray, and the square wave is the trigger signal, indicating that a γ-ray is detected, where a rising edge of the square wave indicates the instant that the γ-ray arrives. At this time, a time-digital converter (TDC) in the tomography system converts a time difference between the rising edge of the trigger signal and a rising edge of an adjacent system main clock into a digital value, and the value is referred to as a time mark, which is registered in the FIFO memory.

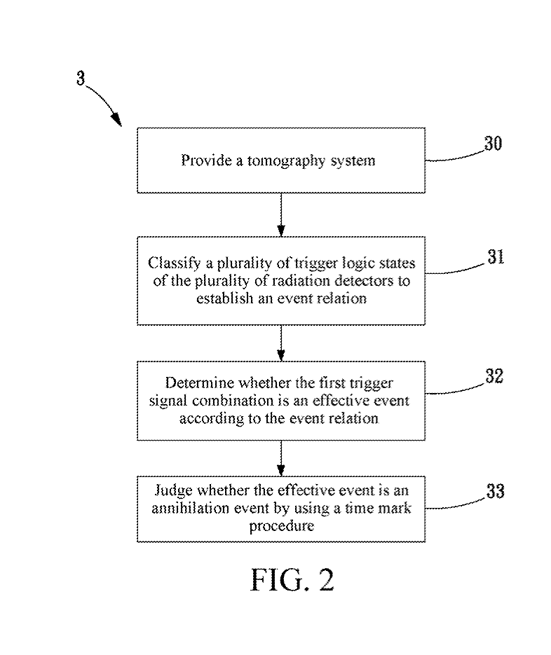

The manner of judging the occurrence of the annihilation event in the present invention is illustrated as follows. Referring to FIG. 2, a schematic flow chart of a method of coincidence detection according to an embodiment of the present invention is shown. By using the system 2 as shown in FIG. 1, it can be judged whether trigger signals, generated in the plurality of radiation detectors 21-24, belong to the same annihilation event. The method of coincidence detection 3 includes the following steps. First, in Step 30, a tomography system is provided. The system has a plurality of radiation detectors and generates a main clock signal, in which each radiation detector detects a radiation event to generate a corresponding trigger signal. A structure of the tomography system in Step 30 is shown in FIG. 1, and is not repeated herein.

In Step 31, a plurality of trigger logic states of the plurality of radiation detectors 21-24 is classified to establish an event relation. In this step, all the trigger signal combinations of the plurality of radiation detectors 21-24 are classified, and all possible combinations of the trigger signals of the plurality of radiation detectors 21-24 are integrated into corresponding addresses. Then, the plurality of groups of trigger signal combinations is classified. Basically, the classification results may be divided into the following five types: (1) no trigger signal, (2) two trigger signals belonging to non-matching modules, (3) a single trigger signal, (4) two trigger signals belonging to matching modules, and (5) multiple trigger signals (three trigger signals or more). Each type is allocated with a matching information code. Thereby, the look-up table formed by the event relation can be electronized, thus forming the state as shown in Table 1, so as to be stored in the memory module.

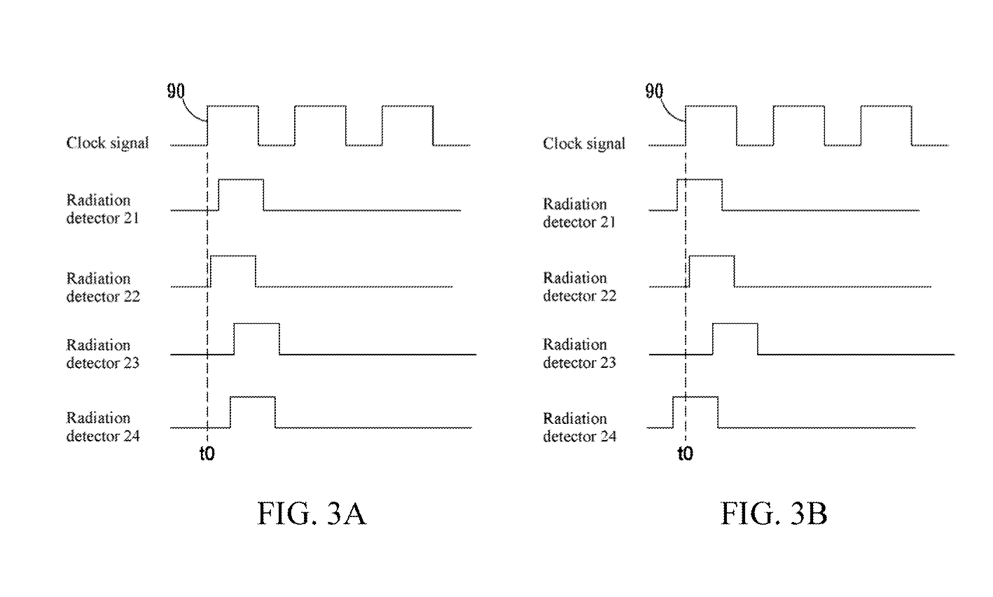

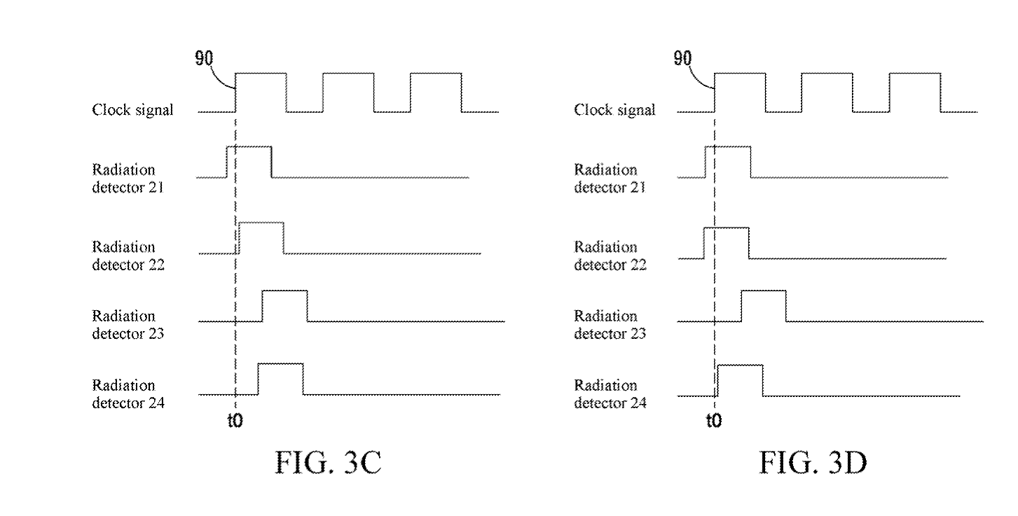

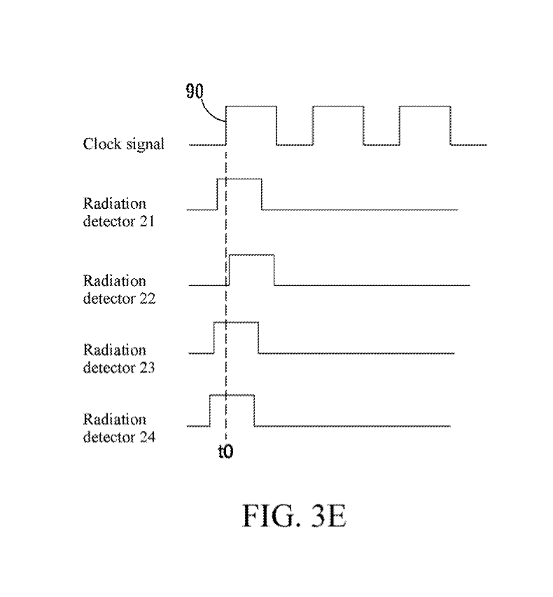

An object under test is then placed in the tomography system for detection, and since the object under test is injected with glucose having radioactive medicine, the medicine is absorbed by malignant cells in a large amount, positrons during the decay process impact with electrons in the cells to counteract with each other thus generating annihilation, the mass disappears and two γ-rays in opposite directions and having an included angle of 180 degrees are emitted. At this time, the control unit 26 scans a first trigger signal combination of the plurality of radiation detectors at a time point of a first rising edge of the main clock signal. Referring to FIGS. 3A to 3E, schematic views of various scanning states are shown. FIG. 3A represents that when the main clock signal is at a time point t0 of the first rising edge 90, the first trigger signal combination of the plurality of radiation detectors is “0000”, which belongs to the type of information code “0000” in Table 1, that is, no trigger signal is generated. FIG. 3B represents that when the main clock signal is at the time point t0 of the first rising edge 90, a detected trigger signal combination is “1001”, which belongs to the type of information code “0010” in Table 1, that is, two trigger signals belonging to non-matching radiation detectors are detected. FIG. 3C represents that when the main clock signal is at the time point t0 of the first rising edge 90, a detected trigger signal combination is “1000”, which belongs to the type of information code “0001” in Table 1, that is, a single trigger signal is detected. FIG. 3D represents that when the main clock signal is at the time point t0 of the first rising edge 90, a detected trigger signal combination is “1100”, which belongs to the type of information code “0011” in Table 1, that is, two trigger signals belonging to matching radiation detectors are detected. Finally, FIG. 3E represents that when the main clock signal is at the time point t0 of the first rising edge 90, a detected trigger signal combination is “1011”, which belongs to the type of information code “0100” in Table 1, that is, multiple trigger signals (three trigger signals or more) are detected.

In Step 32, after scanning at the time point t0, a first trigger signal combination corresponding to the plurality of radiation detectors 21-24 at the time point t0 is obtained, and a look-up table circuit 260 determines whether the first trigger signal combination is an effective event according to the event relation. In this embodiment, the so-called effective event means the single trigger signal of the information code type “0001” and the two trigger signals belonging to matching radiation detectors of the information code type “0011”. If the first trigger signal combination obtains the information code “0001” or “0011” after looking up the table according to the content of Table 1, it is judged that the first trigger signal combination is an effective event; on the contrary, if the information code is of the other three types, the first trigger signal combination is discarded, and the scanning is performed once again at a rising edge of a next main clock signal. After judging that the first trigger signal combination is an effective event according to Step 32, Step 33 is performed, in which a time mark procedure is used to judge whether the effective event is an annihilation event.

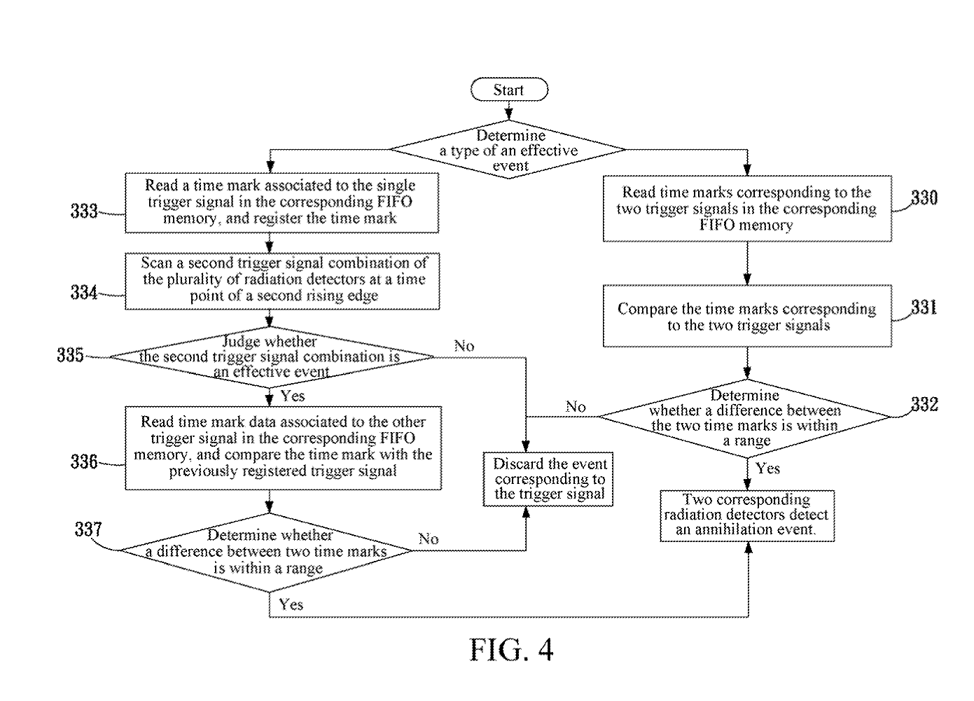

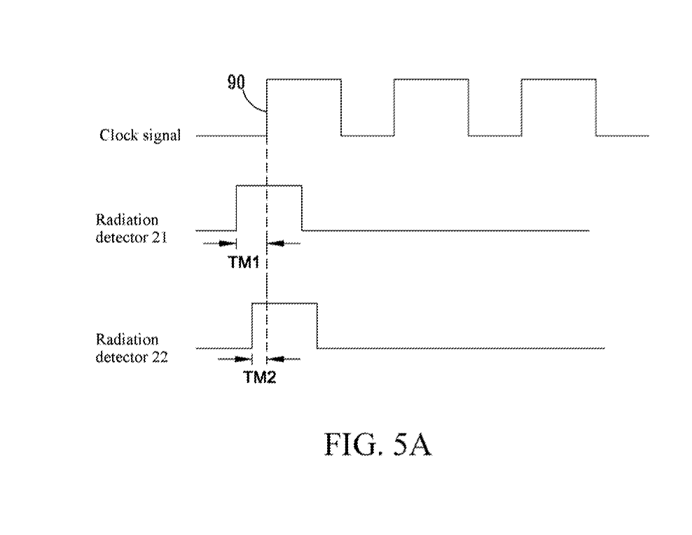

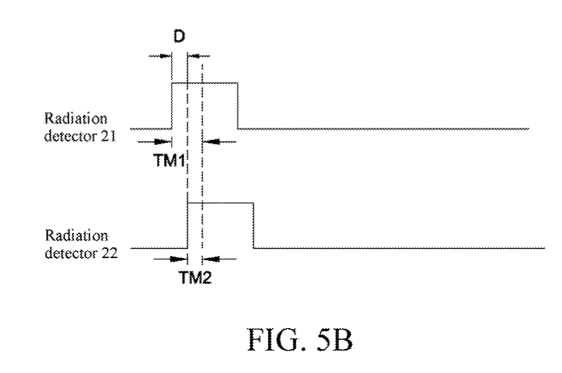

A mode of judging the annihilation event in Step 33 is illustrated as follows. Referring to FIG. 4, a type of the effective event is determined first. If the information code received by the time mark comparator circuit represents two trigger signals and belongs to the matching information code of matching radiation detectors, Step 330 is performed to read time marks corresponding to the two trigger signals from the FIFO memory, and Step 331 is performed to compare the time marks corresponding to the two trigger signals. Referring to FIG. 5A, a schematic view of two matching radiation detectors having trigger signals is shown. In FIG. 5A, the time mark corresponding to the trigger signal of the radiation detector 21 is TM1, and the time mark corresponding to the trigger signal of the radiation detector 22 is TM2. Step 332 is then performed to determine a difference between the two time marks TM1 and TM2. As shown in FIG. 5B, if the difference D between the time marks TM1 and TM2 corresponding to the two trigger signals is within a coincidence time window, it is judged that the two corresponding radiation detectors detect an annihilation event. The size of the coincidence time window is determined as desired.

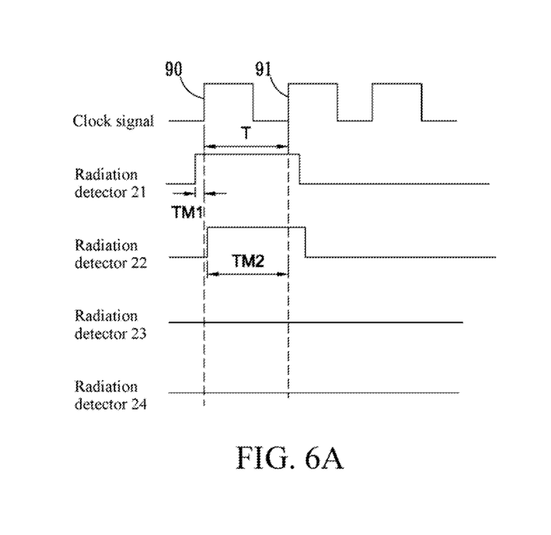

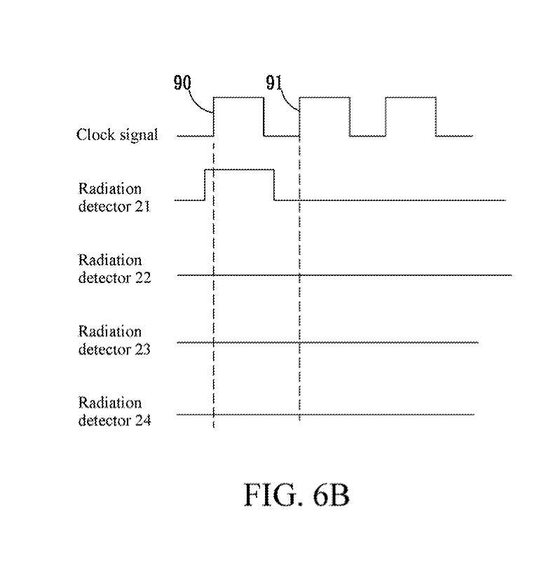

Referring to FIG. 5, when the information code received by the time mark comparator circuit is a single trigger signal, Step 333 is performed to read the time mark associated to the single trigger signal from the FIFO memory, and register the time mark. Then, Step 334 is performed to scan a second trigger signal combination of the plurality of radiation detectors at a time point of a second rising edge 91. Next, Step 335 is performed to judge whether the second trigger signal combination conforms the condition of the effective event or not. In Step 335, referring to FIG. 6A, the second trigger signal combination associated to the plurality of radiation detectors is “1100”, and since the two radiation detectors 21 and 22 are matching, and the radiation detector corresponding to one of the trigger signals is the radiation detector 21 of the single trigger signal, it is indicated that a coincidence possibly occurs. At this time, Step 336 is performed to read the time mark data associated to the other trigger signal from the corresponding FIFO memory 251 and compare the time mark with the trigger signal associated to the radiation detector 21 registered in advance in Step 333. However, a leading edge 90 of the main clock signal adjacent to the previous trigger signal is earlier than a leading edge 91 of the main clock signal adjacent to a next trigger signal for a period of T, so the value of the time mark of the previous trigger signal should be added with the value T representing the period of the main clock signal. Finally, Step 337 is performed, in which if the difference between the two time marks is within a coincidence time window, it is judged that the two corresponding radiation detectors detect an annihilation event. On the contrary, registered data of the event corresponding to the trigger signal is discarded. In addition, as shown in FIG. 6B, if a second trigger signal combination of the plurality of radiation detectors scanned at the time point of the second rising edge 91 is a combination belonging to “0000” or of other aspects not belonging to the effective event combination, the single event is discarded as well.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of coincidence detection, comprising:
providing a tomography system, wherein the tomography system has a plurality of radiation detectors and generates a main clock signal, and each radiation detector detects a radiation event to generate a corresponding trigger signal;
classifying a plurality of trigger logic states of the plurality of radiation detectors, so as to establish an event relation;
scanning a first trigger signal combination of the plurality of radiation detectors at a time point of a first rising edge of the main clock signal;
determining whether the first trigger signal combination is an effective event according to the event relation; and
judging whether the effective event is an annihilation event by using a time mark procedure.

2. The method of coincidence detection according to claim 1, wherein the effective event is a single trigger signal event or a two trigger signal event of two corresponding radiation detectors.

3. The method of coincidence detection according to claim 2, wherein the time mark procedure further comprises:
when each radiation detector generates the trigger signal, recording a time mark associated to the trigger signal corresponding to each radiation detector;
when the effective event is the two trigger signal event, comparing the time marks corresponding to the two trigger signals; and
if a difference between the time marks corresponding to the two trigger signals is within a coincidence time window, judging that the two corresponding radiation detectors detect an annihilation event.

4. The method of coincidence detection according to claim 2, wherein the time mark procedure further comprises:
when each radiation detector generates the trigger signal, recording a time mark associated to the trigger signal corresponding to each radiation detector;
when the effective event is a single trigger signal event, storing the time mark corresponding to the single trigger signal;
scanning a second trigger signal combination of the plurality of radiation detectors at a time point of a second rising edge;
if the second trigger signal combination is the two trigger signal event, and the radiation detector corresponding to one of the trigger signals is the radiation detector of the single trigger signal, comparing a first time mark obtained by adding the stored time mark and a period of the main clock signal with a second time mark corresponding to the trigger signal of the other radiation detector; and
if a difference between the first time mark and the second time mark is within a coincidence time window, judging that the two corresponding radiation detectors detect an annihilation event.

5. A tomography system, comprising:
a main clock generator, for generating a main clock signal;
a plurality of radiation detectors, for respectively detecting a radiation event to generate a corresponding trigger signal;
a memory module, for storing an event relation established by classifying a plurality of trigger logic states of the plurality of radiation detectors and a time mark associated to the trigger signal; and
a control unit, for scanning a first trigger signal combination of the plurality of radiation detectors at a time point of a first rising edge of the main clock signal, determining whether the first trigger signal combination is an effective event according to the event relation, and if yes, judging whether the effective event is an annihilation event by using time marks corresponding to the trigger signals in the effective event.

6. The tomography system according to claim 5, wherein the effective event is a single trigger signal event or a two trigger signal event of two corresponding radiation detectors.

7. The tomography system according to claim 6, wherein the control unit further comprises a time mark comparison circuit, for comparing the time marks corresponding to the two trigger signals when the effective event is the two trigger signal event, and if a difference of the time marks corresponding to the two trigger signals is within a coincidence time window, the control unit judges that the two corresponding radiation detectors detect an annihilation event.

8. The tomography system according to claim 6, wherein the control unit further comprises a time mark comparison circuit, the control unit stores the time mark corresponding to the signal trigger signal in the memory module when the effective event is the signal trigger signal event, and scans a second trigger signal combination of the plurality of radiation detectors at a time point of a second rising edge; if the second trigger signal combination is the two trigger signal event, and the radiation detector corresponding to one of the trigger signals is the radiation detector of the single trigger signal, the time mark comparison circuit compares a first time mark obtained by adding the stored time mark and a period of the main clock signal with a second time mark corresponding to the trigger signal of the other radiation detector; and if a difference between the first time mark and the second time mark is within a coincidence time window, the control unit judges that the two corresponding radiation detectors detect an annihilation event.

9. The tomography system according to claim 5, wherein the memory module further comprises a read-only memory (ROM) unit for storing the event relation and a first-in first-out (FIFO) memory unit for storing the time mark.
